(19) United States
(12) Patent Application Publication
(10) Pub. No.: US 2021/0336848 A1
(43) Pub. Date: Oct. 28, 2021

(54) SYSTEM FOR NETWORKING DEVICE WITH DATA MODEL ENGINES FOR CONFIGURING NETWORK PARAMETERS

(71) Applicant: Puneet Kumar Agarwal, Gurgaon (IN)

(72) Inventors: Puneet Kumar Agarwal, Gurgaon (IN); Vishnu K, Gurgaon (IN); Kautuk Consul, Gurgaon (IN); Ankit Singh, Gurgaon (IN)

(21) Appl. No.: 17/125,429

(22) Filed: Dec. 17, 2020

(30) Foreign Application Priority Data
Apr. 27, 2020 (IN) 202011018004

(51) Int. Cl. H04L 12/24

(52) U.S. Cl. CPC H04L 41/0816; H04L 41/0843; H04L 41/0883

(57) ABSTRACT

The present disclosure provides a system for providing a plurality of data models for a networking device. The system includes a network operating system and a plurality of data model engine modules. The network operating system stores the plurality of data models. Each of the plurality of data model engine modules corresponds to a specific data model from the plurality of data models in the network operating system. In addition, the plurality of data models is used by the networking device simultaneously in real-time. Further, the networking device is a white box hardware device. Furthermore, the networking device includes one or more transponders, one or more switches, and one or more routers. Moreover, the plurality of data models includes one or more vendor neutral data models, one or more open data models, and one or more vendor proprietary data models.

### BACKGROUND OF THE INVENTION

### Field of the Invention

The present disclosure relates to the field of communication networks and, in particular, relates to a system for networking device with data model engines for configuring network parameters. The present disclosure is based on, and claims priority from an Indian application with application number 202011018004 filed on 27 Apr. 2020, the disclosure of which is hereby incorporated by reference herein.

### Description of the Related Art

Optical fibres have secured an important position in building optical network of modern communication systems across the world. Network operators utilize a networking device to establish an optical network. Conventionally, the networking device utilized by each network operator is only dependent on single data model for network management. In general, data models define how data is connected, processed and stored inside a system. In addition, the networking device is utilized by original equipment manufacturers (OEMs) to support their proprietary data models. Further, the proprietary data models are only integrated with proprietary element management system (EMS) or network management system (NMS) or controller platforms. Furthermore, these proprietary data models bound the network operators to lock-in to the OEMs to roll out network services. Currently, the network operators utilize informal groups, such as OpenConfig, OpenROADM, and the like. In addition, the informal groups convert networking world into dynamic programmable infrastructure. Further, the dynamic programmable infrastructure provides a vendor-neutral approach to the network operators. These informal groups have defined a vendor-neutral data models for configuration and management of L0, L1, L2 and L3 features depending on their workgroup focus areas. However, the current methodology is immature for all technology domains. In addition, the current methodology has major feature gaps within specific technology domains which limit the network operators to use these specific technology domains for commercial-grade systems. Further, the current methodology is inefficient to configure and manage end-to-end services. Furthermore, the current methodology is inefficient to have full coverage of features across all technology domains. Moreover, limited feature coverage of open data models across technology domains restricts customers to deploy services through open data models. There are many systems for managing the data models. Some of the prior art references are given below:

U.S. Pat. No. 9,715,380B2 discloses techniques for enabling dynamic update of device data models and an apparatus is provided. The apparatus transmits a message from a network element to a network controller. In addition, the apparatus identifies a data store of the network controller and a data model and a transformation document stored in the identified data store. Further, the apparatus downloads the identified data model and identified transformation document to the network element. The apparatus applies the downloaded transformation document to the downloaded data model to generate a platform interface file. The apparatus programs the platform interface file at the network element.

JP2019180052A discloses program, device, system and method for mapping unknown data model of a tree structure to a common data model. The system matches an unknown data model to a common data model for a tree-structured data model consisting of a parent node and a child node. In addition, the nodes of the known data model as the teacher data are matched to the nodes of the common data model. Further, a parent-child node decomposition means for decomposing a known data model into a parent node and a child node group. Furthermore, the system associates a “child node group of known data models” with a “parent node of a common data model” matched with a parent node of a known data model connected to these child node groups.

US20180013662A1 discloses method and apparatus for mapping network data models. The apparatus includes an interface to receive network data in a network. The network includes a plurality of network components. Each of the network components associated with one of a plurality of network data models. The apparatus includes a processor to perform semantic matching for at least two of the network data models. The apparatus maps the network data models based on said semantic matching for use in a network application. The apparatus includes a memory to store a lexical database for use in said semantic matching.

In light of the above-stated discussion, there is a need to overcome these above-mentioned disadvantages.

### BRIEF SUMMARY OF THE INVENTION

In an aspect, the present disclosure provides a method for using a plurality of data models in a networking device. The method includes a first step to add the plurality of data models in a network operating system. In addition, the method includes a second step to create a plurality of data model engine modules. Further, the method includes a third step to communicate with the network operating system to use one or more data model engines for configuration of one or more network parameters in the networking device. Furthermore, each of the plurality of data model engine modules corresponds to a specific data model from the plurality of data models.

A primary object of the present disclosure is to provide a system for a networking device for configuring network parameters provided by a Software defined networking (SDN) controller.

Another object of the present disclosure is to provide the system to assist service providers to utilize multiple data models for wide coverage of network parameters over the networking device.

Yet another object of the present disclosure is to provide the system to allow the service providers to utilize multiple data models in parallel for configuration and management for the network parameters.

Yet another object of the present disclosure is to provide the system to use open data models of the networking device to utilize a wide range of features for supporting multiple data models over the networking device.

Yet another object of the present disclosure is to provide the system to use the open data models to provide open access to the service providers to element management system (EMS) or network management system (NMS) or controller platforms.

In an embodiment of the present disclosure, the plurality of data models is used by the networking device simultaneously in real-time.

In an embodiment of the present disclosure, the networking device is a white box hardware device.

In an embodiment of the present disclosure, the networking device includes one or more transponders, one or more switches, and one or more routers.

In an embodiment of the present disclosure, the plurality of data models includes one or more vendor neutral data models, one or more open data models, and one or more vendor proprietary data models.

In an embodiment of the present disclosure, the plurality of data models is provided by one or more vendor neutral groups. In addition, the one or more vendor neutral groups include at least one of OpenCONFIG and OpenROADM.

In another aspect, the present disclosure provides a system for providing a plurality of data models for a networking device. The system includes a network operating system and a plurality of data model engine modules. In addition, the network operating system stores the plurality of data models. Further, each of the plurality of data model engine modules corresponds to the specific data model from the plurality of data models in the network operating system.

### DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates a general overview of a system for configuring one or more network parameters using one or more data model engines associated with a networking device, in accordance with various embodiments of the present disclosure;

FIG. 2 illustrates a flow chart of a method for configuring the one or more network parameters using the one or more data model engines associated with the networking device, in accordance with various embodiments of the present disclosure; and

FIG. 3 illustrates a hardware framework of the system of FIG. 1, in accordance with various embodiments of the present disclosure.

It should be noted that the accompanying figures are intended to present illustrations of few exemplary embodiments of the present disclosure. These figures are not intended to limit the scope of the present disclosure. It should also be noted that accompanying figures are not necessarily drawn to scale.

### REFERENCE NUMERALS IN THE DRAWINGS

For a more complete understanding of the present invention parts, reference is now made to the following descriptions:
100. The system.
102. Configuration manager middleware.
104. Network operating system.
106. Data model engines.
108. Hardware abstraction layer.
110. Networking device.
200. Flow chart.
202. Start step.
204. Add a plurality of data models in a network operating system.
206. Create a plurality of data model engine modules.
208. Communicate with the network operating system for using one or more data model engines for configuration of one or more network parameters in a networking device.
210. Stop step.
300. Hardware framework.
302. Bus.
304. Memory.
306. Processors.
308. Presentation components.
310. Input/output (I/O) ports.
312. Input/output components.
314. Power supply.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

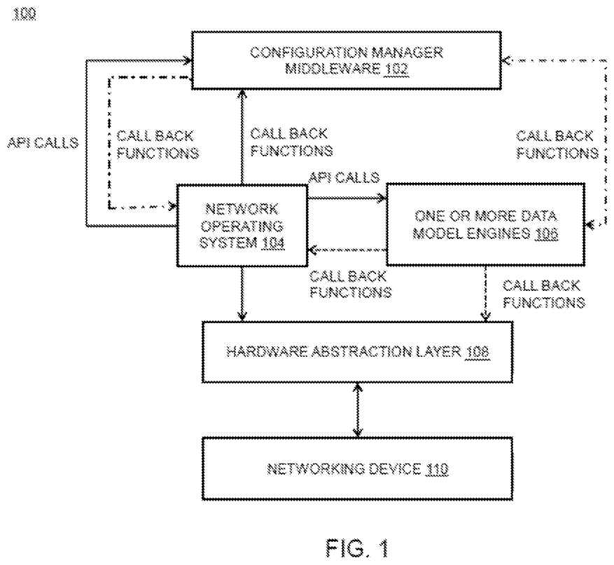

FIG. 1 illustrates a general overview of a system 100 to configure one or more network parameters using one or more data model engines 106 associated with a networking device 110, in accordance with various embodiments of the present disclosure. The system 100 includes a configuration manager middleware 102, a network operating system 104, the one or more data model engines 106, a hardware abstraction layer 108 and the networking device 110. In addition, the system 100 adds a plurality of data models in the network operating system 104. Further, the system 100 creates a plurality of data model engine modules. Furthermore, each of the plurality of data model engine modules corresponds to a specific data model from the plurality of data models. Moreover, the system 100 communicates with the network operating system 104 for using the one or more data model engines 106 for configuration of the one or more network parameters in the networking device 110.

The system 100 includes the configuration manager middleware 102. In an embodiment of the present disclosure, the configuration manager middleware 102 manages network-based requests initiated by a client. In addition, the configuration manager middleware 102 manages one or more operations related to network hardware and software. In general, the configuration manager middleware 102 incorporates multiple configurations and set up processes on network-based hardware and software. In an embodiment of the present disclosure, the configuration manager middleware 102 connects with the network operating system 104 through API calls. In an embodiment of the present disclosure, the configuration manager middleware 102 generates multiple parents-to-multiple children (M2M) application layer multicast (ALM) overlay structure. In addition, the configuration manager middleware 102 maintains the multiple parents-to-multiple children (M2M) application layer multicast (ALM) overlay structure. Further, the configuration manager middleware 102 communicate with end-nodes to provide and gather configuration information.

The system 100 includes the network operating system 104. In general, the network operating system 104 is used to manage communications on the network. In addition, the network operating system 104 coordinates with network resources. Further, the network operating system 104 resides on a computer or a dedicated server computer. Furthermore, the network operating system 104 provides services to the client over the network. Moreover, the network operating system 104 provides network administration utilities. Also, the network resources include switches, routers, DNS, VLAN, IP addresses, and the like. In an embodiment of the present disclosure, the network operating system 104 communicates with the configuration manager middleware 102 through callback functions. In addition, the network operating system 104 stores the plurality of data models. In general, the callback function refers to function that is passed as argument to another function, to be called back at later time. In addition, the call back function accepts other functions as arguments is known as high-order function. Further, the call back function contains logic to be executed.

The system 100 includes the one or more data model engines 106. In general, data models are processed at the networking devices 110 over the network. In an embodiment of the present disclosure, the one or more data model engines 106 enable the networking device 110 to process the plurality of data models. In addition, the plurality of data models utilizes data modelling process to create the plurality of data model engine modules to be stored in a database. Further, the plurality of data models corresponds to conceptual representation of data objects. Furthermore, the plurality of data models corresponds to connection between data objects and rules. Moreover, the plurality of data models facilitates in visual representation of data and enforces business rules, regulatory compliances, government policies on data, and the like. Also, the plurality of data models accentuates data and organizes operations to be performed. Also, the plurality of data models is used by the networking device 110 simultaneously in real-time. Also, the plurality of data models includes one or more vendor neutral data models, one or more open data models, one or more vendor proprietary data models, and the like. In general, vendor neutral data model allows data centre providers to limit activities to fixed set of value layers in order to avoid conflicts of interest. In general, open data model provides common taxonomy to describe security telemetry data used to detect threats. In an embodiment of the present disclosure, the plurality of data models is provided by one or more vendor neutral groups. In addition, the one or more vendor neutral groups include at least one of OpenCONFIG and OpenROADM. Further, the one or more vendor neutral groups allow the networking device 110 to seamlessly integrate with the network operating system 104 and the one or more model engines 106.

In an embodiment of the present disclosure, the one or more data model engines 106 create and handle the configuration manager middleware 102 through access call points. The one or more data model engines 106 handle database subscriptions for YANG paths in corresponding data model of the one or more data model engines 106. In an embodiment of the present disclosure, each data model of the one or more data model engines 106 is associated with each YANG data model. Each YANG data model handles distinct paths in each data model of the one or more data model engines 106.

In an embodiment of the present disclosure, the one or more data model engines 106 utilize callback functions provided by the network operating system 104. The callback functions are utilized by the one or more data model engines 106 to communicate with the hardware abstraction layer 108. Further, the callback functions are utilized by the one or more data model engines 106 to communicate with the network operating system 104. Furthermore, the callback functions are utilized by the one or more data model engines 106 to communicate with the configuration manager middleware 102. In an embodiment of the present disclosure, the one or more data model engines 106 are independent of software layers present in environment associated with the network operating system 104.

The system 100 includes the hardware abstraction layer 108. In general, the hardware abstraction layer 108 is layer of programming that allows computer operating system to interact with optical hardware devices at abstract level. In an embodiment of the present disclosure, the hardware abstraction layer 108 serves as an abstraction layer between the one or more data model engines 106 and the networking device 110. In addition, the hardware abstraction layer 108 provides a device driver interface that allows the one or more data model engines 106 to communicate with the networking device 110. Further, the hardware abstraction layer 108 allows the network operating system 104 and the one or more data model engines 106 to discover and use one or more network components of the networking device 110. Furthermore, each of the one or more network components is connected to each model of the plurality of data models.

The system 100 includes the networking device 110. In addition, the plurality of data models is used by the networking device 110 simultaneously in real-time. In an embodiment of the present disclosure, the networking device 110 is a white box hardware device. In addition, the networking device 110 include but may not be limited to one or more transponders, one or more switches, and one or more routers. In general, transponder is a device that receives signal and emits different signals in response. In addition, the transponder converts electrical signals into optical signals and optical signals to electrical signals. In an embodiment of the present disclosure, the one or more transponders transmits and receives optical signals from optical fibre. In addition, the one or more transponders are characterized by data rate and maximum distance travelled by signal. Further, the one or more transponders are multi-rate and bidirectional fibre transponders. Furthermore, the one or more transponders are used to test interoperability and compatibility.

In an embodiment of the present disclosure, the system 100 facilitates service providers to receive support of the one or more data model engines 106 over the networking device 110. In addition, the system 100 allows the service providers to use the one or more data model engines 106 in parallel for configuration and management for the one or more network parameters. In an example, data model engine E1 allows the service providers open access to element management system (EMS) or network management system (NMS). In addition, the element management system (EMS) or network management system (NMS) supports data model engine E1.

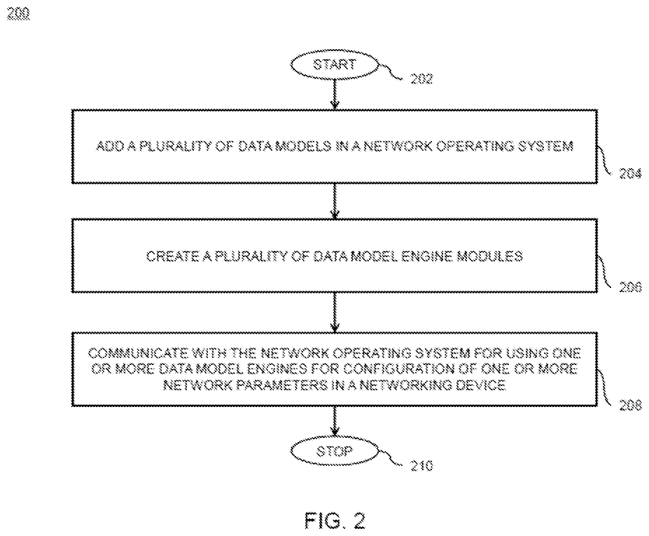

FIG. 2 illustrates a flow chart 200 of a method for configuring the one or more network parameters using the one or more data model engines 106 associated with the networking device 110, in accordance with various embodiments of the present disclosure. It may be noted that in order to explain the method steps of the flowchart 200, references will be made to the elements explained in FIG. 1. The flow chart 200 starts at step 202. At step 204, the system 100 adds the plurality of data models in the network operating system 104. At step 206, the system 100 creates the plurality of data model engine modules. At step 208, the system 100 communicates with the network operating system 104 for using the one or more data model engines 106 for configuration of the one or more network parameters in the networking device 110.

The flow chart 200 terminates at step 210. It may be noted that the flow chart 200 is explained to have above stated process steps; however, those skilled in the art would appreciate that the flow chart 200 may have more/less number of process steps which may enable all the above stated embodiments of the present disclosure.

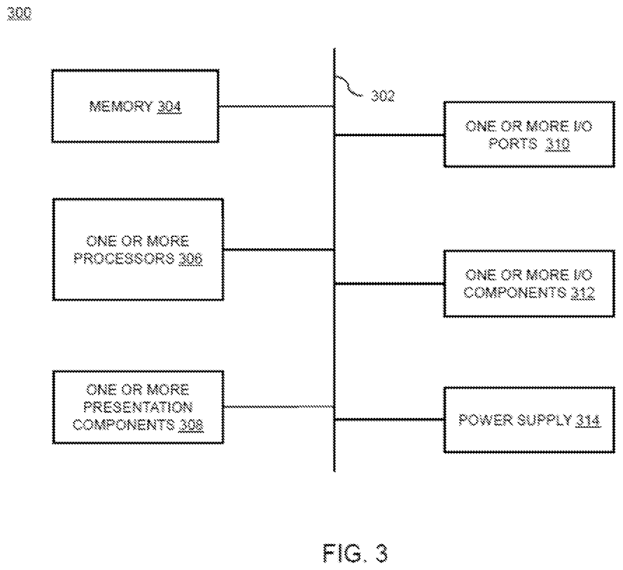

FIG. 3 illustrates a hardware framework 300 of the system 100, in accordance with various embodiments of the present disclosure. The system 100 is a non-transitory computer-readable storage medium. The system 100 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 3 is merely illustrative of an exemplary device that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The system 100 typically includes a variety of computer-readable media. The computer-readable media can be any available media that can be accessed by the system 100 and includes both volatile and non-volatile media, removable and non-removable media. By way of example, and not limitation, the computer-readable media may comprise computer storage media and communication media. The computer storage media includes volatile and non-volatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the system 100. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or non-volatile memory. The memory 304 may be removable, non-removable, or a combination thereof. Exemplary hardware devices include solid-state memory, hard drives, optical-disc drives, etc. The system 100 includes the one or more processors 306 that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the system 100 to be logically coupled to other devices including the one or more I/O components 312, some of which may be built in. Illustrative components include a microphone, joystick, game pad, satellite dish, scanner, printer, wireless device, etc.

The present invention has various advantages over the prior art. The present invention relates to the system 100 for the networking device for configuring network parameters provided by a SDN controller. In addition, the system 100 assists service providers to utilize multiple data models for wide coverage of network parameters over the networking device 110. Further, the system 100 allows the service providers to utilize multiple data models in parallel for configuration and management for the network parameters. Furthermore, the system 100 uses open data models of the networking device 110 to utilize a wide range of features for supporting multiple data models over the networking device 110. Moreover, the system 100 uses the open data models to provide open access to the service providers to element management system (EMS) or network management system (NMS) or controller platforms.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Although the present disclosure has been explained in relation to its preferred embodiment(s) as mentioned above, it is to be understood that many other possible modifications and variations can be made without departing from the spirit and scope of the inventive aspects of the present invention. It is, therefore, contemplated that the appended claim or claims will cover such modifications and variations that fall within the true scope of the invention.

What is claimed is:

1. A method for using a plurality of data models in a networking device, the method comprising:
adding, by a system, the plurality of data models in a network operating system;
creating, by the system, a plurality of data model engine modules, wherein each of the plurality of data model engine modules corresponds to a specific data model from the plurality of data models; and
communicating, by the system, with the network operating system for using one or more data model engines for configuration of one or more network parameters in the networking device.

2. The method as claimed in claim 1, wherein the plurality of data models are used by the networking device simultaneously in real-time.

3. The method as claimed in claim 1, wherein the networking device is a white box hardware device.

4. The method as claimed in claim 1, wherein the networking device comprises at least one of one or more transponders, one or more switches, and one or more routers.

5. The method as claimed in claim 1, wherein the plurality of data models comprises at least one of: one or more vendor neutral data models, one or more open data models, and one or more vendor proprietary data models.

6. The method as claimed in claim 1, wherein the plurality of data models is provided by one or more vendor neutral groups, wherein the one or more vendor neutral groups comprise at least one of OpenCONFIG and OpenROADM.

7. A system for providing a plurality of data models for a networking device, the system comprising:
a network operating system, wherein the network operating system stores the plurality of data models; and
a plurality of data model engine modules, wherein each of the plurality of data model engine modules corresponds to a specific data model from the plurality of data models in the network operating system.

8. The system as claimed in claim 7, wherein the plurality of data models is used by the networking device simultaneously in real-time.

9. The system as claimed in claim 7, wherein the networking device is a white box hardware device.

10. The system as claimed in claim 7, wherein the networking device comprises at least one of one or more transponders, one or more switches, and one or more routers.

11. The system as claimed in claim 7, wherein the plurality of data models comprises at least one of: one or more vendor neutral data models, one or more open data models, and one or more vendor proprietary data models.

12. The system as claimed in claim 7, wherein the plurality of data models is provided by one or more vendor neutral groups, wherein the one or more vendor neutral groups comprise at least one of OpenCONFIG and OpenROADM.
